(19) United States
(12) Patent Application Publication
(10) Pub. No.: US 2026/0119563 A1
(43) Pub. Date: Apr. 30, 2026

(54) SERVER FOR RECOMMENDING CUSTOMIZED MODEL BASED ON PREDICTIVE MODEL AND METHOD OPERATION THEREOF

(71) Applicant: NURIE AI Inc., Incheon (KR)

(72) Inventors: Young-Tae DO, Seoul (KR); Su-hee CHOI, Uijeongbu-si (KR)

(21) Appl. No.: 19/374,281

(22) Filed: Oct. 30, 2025

(30) Foreign Application Priority Data
Oct. 30, 2024 (KR) 10-2024-0151614
Jul. 16, 2025 (KR) 10-2025-0095814

(51) Int. Cl. G06F 16/353; G06F 16/34; G06F 16/55

(52) U.S. Cl. CPC G06F 16/353; G06F 16/345; G06F 16/55

(57) ABSTRACT

According to various embodiments, a server for recommending a customized model based on a predictive model includes: a communication interface; and a processor, wherein the processor is configured to: receive at least one user data item from an external electronic device of the user through the communication interface; determine text data for the user by inputting the at least one user data item into a first sub-deep learning model; determine image data for the user by inputting the at least one user data item into a second sub-deep learning model; determine a customized model for the user by inputting at least one or more of the text data and/or the image data into the predictive model; and transmit the customized model to the external electronic device of the user through the communication interface.

### CROSS REFERENCE TO RELATED APPLICATION

This application claims the benefit of Korean Patent Application No. 10-2024-0151614, filed with the Korean Intellectual Property Office on Oct. 30, 2024, and Korean Patent Application No. 10-2025-0095814, filed with the Korean Intellectual Property Office on Jul. 16, 2025, the disclosure of which is incorporated herein by reference in its entirety.

### BACKGROUND

### Technical Field

Various embodiments of the present disclosure relate to a server for recommending a customized model based on a predictive model and a method of operating the sever.

### Description of the Related Art

Recently, there has been a wide interest in artificial intelligence technology, and accordingly, individuals have been learning and utilizing artificial intelligence in various ways.

However, the model recommendation methods in the related art have had problems that, for new users or new items, it is difficult to make appropriate recommendations due to insufficient data; that recommendations based on previous interactions fail to reflect changes in user's current interests; that, in the case of similar-user-based recommendations, bias may be introduced within a group; that, when recommending on the basis of only user preferences, information exposure may become biased; that current context, such as weather, location, or emotional state, cannot be reflected; that it is unclear how user data is collected and utilized; and that most existing models are based on text- or click-based and do not properly reflect as voice, touch, images, biometric signals, etc.

Accordingly, there is a need for a system and method capable of easily providing a customized model to a user while overcoming such problems.

### PRIOR ART DOCUMENT

### Patent Document

(Patent Document 0001) Korean Patent No. 10-2831702 (Jul. 3, 2025)
(Patent Document 0002) Korean Patent No. 10-2823122 (Jun. 17, 2025)

### SUMMARY

Accordingly, the present embodiment relates to a server capable of easily providing a user with a customized model output by inputting at least one of text data, image data, and/or supplementary data into a predictive model on the basis of a request fro the user, and a method of operating the server.

According to various embodiments, a server for recommending a customized model based on a predictive model includes: a communication interface; and a processor, wherein the processor is configured to: receive at least one user data item from an external electronic device of the user through the communication interface; determine text data for the user by inputting the at least one user data item into a first sub-deep learning model; determine image data for the user by inputting the at least one user data item into a second sub-deep learning model; determine a customized model for the user by inputting at least one or more of the text data and/or the image data into the predictive model; and transmit the customized model to the external electronic device of the user through the communication interface, wherein the predictive model is trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors.

Further, according to other various embodiments, a method of operating a server for recommending a customized model based on a predictive model is configured to: receive at least one user data item from an external electronic device of the user through the communication interface; determine text data for the user by inputting the at least one user data item into a first sub-deep learning model through a processor; determine image data for the user by inputting the at least one user data item into a second sub-deep learning model through the processor; determine a customized model for the user by inputting at least one or more of the text data and/or the image data into the predictive model through the processor; and transmit the customized model to the external electronic device of the user through the communication interface, wherein the predictive model is trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors.

The server according to the present embodiment has the advantage that it can easily perform an analysis on each data by preprocessing at least one user data item acquired from an external electronic device of the user, can extract a customized model according to the selection by using a loss function output by inputting the analysis data into a predictive model, can determine whether the customized model is suitable, and can provide the customized model to the user.

### BRIEF DESCRIPTION OF THE DRAWINGS

FIG. 1 is a block diagram of an electronic device and a network according to various embodiments of the present disclosure;

FIG. 2 is an exemplary diagram for describing a method by which a server is operated according to various embodiments of the present disclosure; and

FIG. 3A, FIG. 3B and FIG. 3C are exemplary diagrams for describing a specific classification of text data by a server according to various embodiments of the present disclosure.

### DETAILED DESCRIPTION

Hereafter, various embodiments of the present disclosure are described with reference to accompanying drawings. Embodiments and terms used in the embodiments are not intended to limit the technical features described herein to specific embodiments and should be understood as including various changes, equivalents, and replacements of corresponding embodiments. In the description of drawings, similar components may be given similar reference numerals. Singular forms are intended to include plural forms unless the context clearly indicates otherwise. In the specification, the terms “A or B”, “at least one of A and/or B”, or the like may include all possible combinations of items to be enumerated. The terms such as “first” and “second” may modify corresponding components regardless of the order or priority and are used only to discriminate one component from another component without limiting the components. When a certain (e.g., first) component is referred to as being “(functionally or communicatively) coupled” or “connected” to another (e.g., second) component, the certain component may be directly connected to the other component, or may be connected to the other component via another component (e.g., a third component).

In the present disclosure, “configured to” (or “set to”) may, depending on the situation, be used interchangeably with, for example, “suitable for ˜,” “having the capability to ˜,” “modified to ˜,” “made to ˜,” “capable of ˜,” or “designed to ˜,” whether in hardware or software. In some circumferences, the term “device configured to” may refer to that the device “is capable of doing” with other devices or parts. For example, a “processor configured to perform expressions A, B, and C” may refer to an exclusive processor (e.g., an embedded processor0 for performing the corresponding operations or a generic-purpose processor (e.g., a CPU or an application processor) being capable of performing the corresponding operations by executing one or more software programs stored in a memory device.

An electronic device according to various embodiments of the present disclosure may include at least one of, for example, a smartphone, a tablet PC, a desktop PC, a laptop PC, a netbook computer, a workstation, and a server.

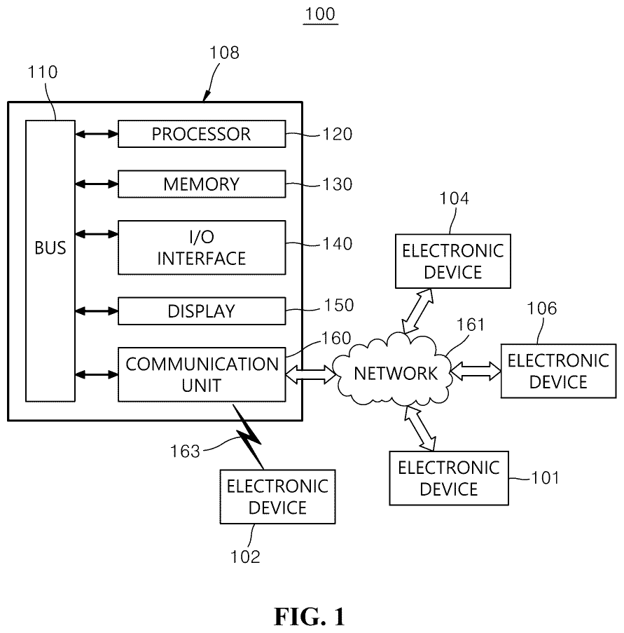

A server 108 in a network environment 100 according to various embodiments is described with reference to FIG. 1. The server 108 may include a bus 110, a processor 120, a memory 130, an I/O interface 140, a display 150, and a communication interface 160. In another embodiment, the server 108 may not include at least one of the components or may additionally include other components. The bus 110 connects the components 110˜160 to each other and may include a circuit that transmits communications (e.g., control messages or data) between the components. The processor 120 may include one or more of a central processing unit, an application processor, or a communication processor (CP). The processor 120, for example, can perform operations or data processing related to control and/or communication of at least one other component of the server 108.

The memory 130 may include a volatile and/or nonvolatile memory. The memory 130 can store, for example, instructions or data related to at least one other component of the server 108. According to an embodiment, the memory 130 can store software and/or a program 140.

The I/O interface 140, for example, can transmit instructions or data input from a patient or another external device to other component(s) of the server 108 or can output instructions or data received from other component(s) of the server 108 to a user or another external device.

The display 150, for example, may include a Liquid Crystal Display (LCD), a Light Emitting Diode (LED) display, an Organic Light Emitting Diode (OLED) display, a Micro Electronic Mechanical System (MEMS) display, or an electronic paper display. The display 150, for example, can display various contents (for example, a text, an image, a video, an icon, and/or a symbol) to a patient. The display 150 may include a touch screen and, for example, can receive touching, gesturing, approaching, or hovering input by an electronic pen or a part of the body of a patient. The communication interface 160, for example, can set communication between the server 108 and an external device (for example, a first external electronic device 102, a second external electronic device 104, or the server 108). For example, the communication interface 160 can be connected to the network 162 and can communicate with an external device (for example, the second external electronic device 104 or the server 108) through wireless communication or wired communication.

The wireless communication may include cellular communication using at least one of LTE, LTE-A (LTE Advance), Code Division Multiple Access (CDMA), Wideband CDMA (WCDMA), Universal Mobile Telecommunications System (UMTS), Wireless Broadband (WiBro), or Global System for Mobile Communications (GSM). According to an embodiment, the wireless communication may include at least one of Wireless Fidelity (WiFi), Bluetooth, Bluetooth Low Energy (BLE), Zigbee, Near Field Communication (NFC), magnetic secure transmission, Radio Frequency (RF), or Body Area Network (BAN). According to an embodiment, the wireless communication may include GNSS. GNSS, for example, may be a Global Positioning System (GPS), a Global Navigation Satellite System (Glonass), a Beidou Navigation Satellite System (hereafter, “Beidou”), a Galileo, or the European global satellite-based navigation system. In the following description, “GPS” may be used interchangeably with “GNSS”. Wired communication, for example, may include at least one of a Universal Serial Bus (USB), a High Definition Multimedia Interface (HDMI), an RS-232 (Recommended Standard-232), power line communication, or a Plain Old Telephone Service (POTS). The network 162 may include at least one of telecommunication networks, for example, a computer network (for example, LAN or WAN), the internet, or a telephone network.

According to various embodiments, the server 108 may operate an application composed of a plurality of execution screens or a website composed of a plurality of web pages, communicate with an electronic device (e.g., the electronic devices 101, 102, 104, and 106 in FIG. 1) (e.g., a smartphone, a laptop, etc.) via the network 161, process a request received in relation to the application or the web page from the electronic device 101, and transmit requested information to the electronic device 101. The server 108 can transmit source code to the electronic device 101 so that each execution screen of a dedicated application or a website can be displayed on the electronic device 101, and the electronic device 101 can receive the source code and display an execution screen requested by a user of the electronic device 101 through the dedicated application or a web browser. According to an embodiment, the components referred to as the electronic device 101 in the present disclosure may refer to a user account that has accessed a platform provided by the server 108 through the corresponding electronic device.

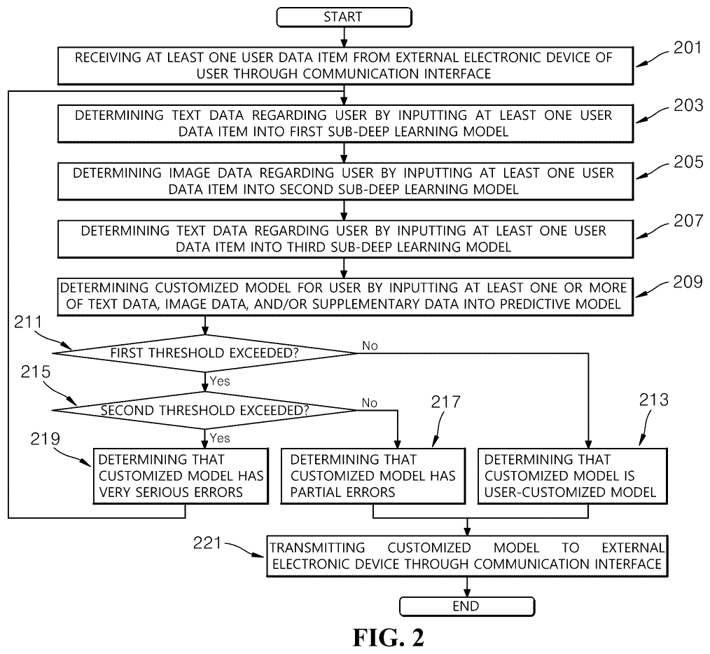

FIG. 2 is an exemplary diagram for describing a method by which a server is operated according to various embodiments of the present disclosure.

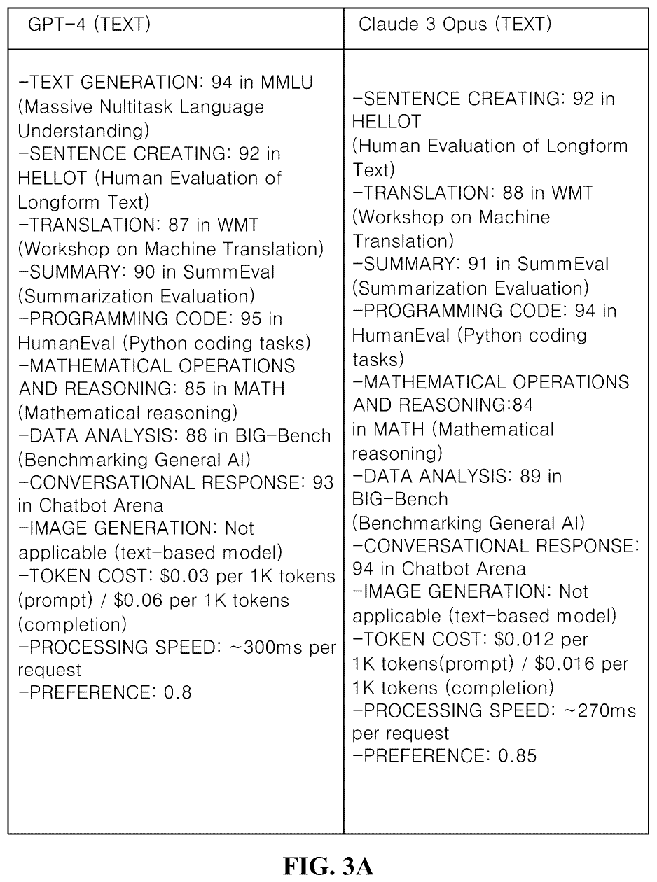

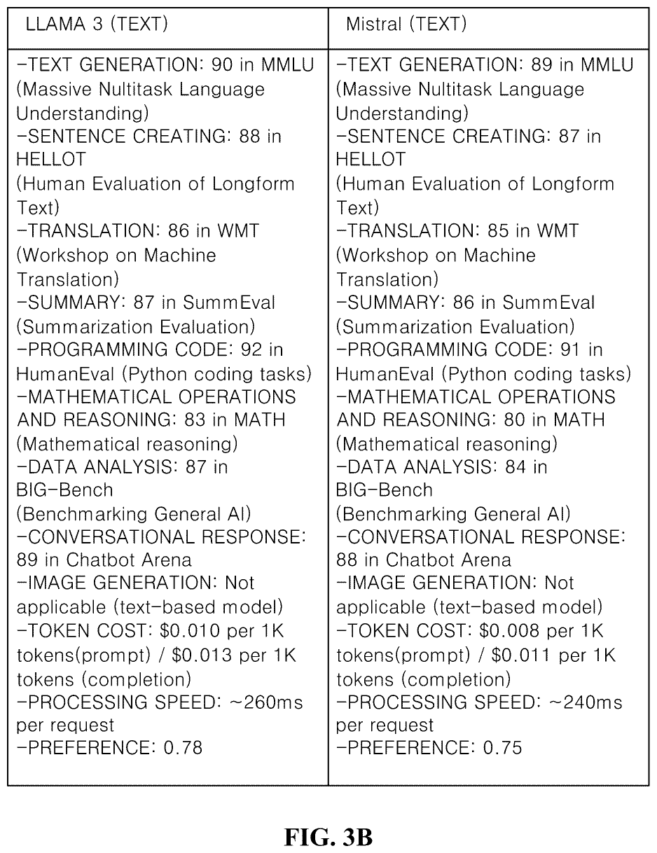

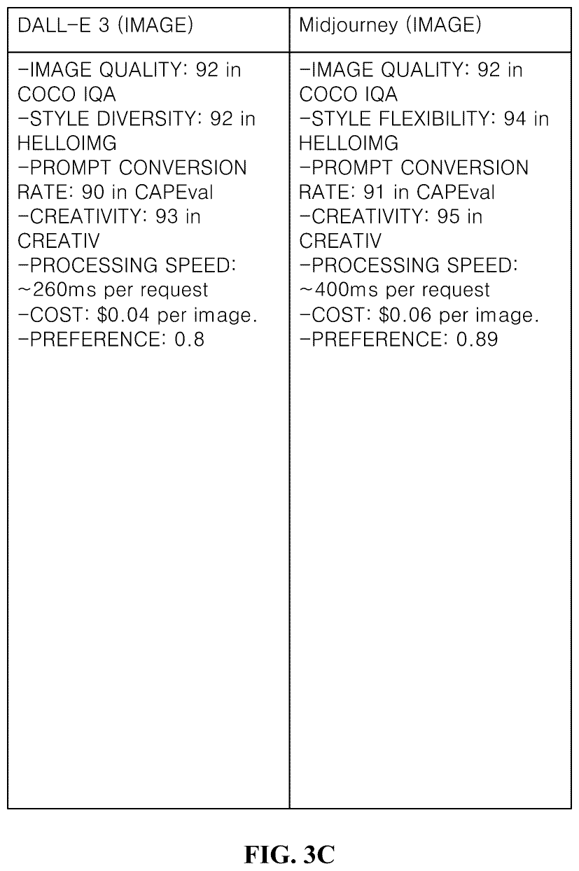

FIG. 3A AND FIG. 3B AND FIG. 3C is an exemplary diagram for describing a specific classification of text data by a server according to various embodiments of the present disclosure.

In operation 201, the server 108 (e.g., the processor 120 of FIG. 1) can receive at least one user data item from user's external electronic devices 101, 102, 104, and 106 through a communication interface (e.g., the communication interface 160 of FIG. 1). According to an embodiment, the at least one user data item may include sentence data created by the user, translation data created by the user, summary data created by the user, conversational data created by the user, voice data sensed or produced by the user, tactile data sensed or produced by the user, olfactory data sensed or produced by the user, input image data visually confirmed by the user or input by the user, analysis data of the user, and mathematical operation data of the user. Specifically, the sentence data may be composed of data regarding a general natural language sentence, and may be composed of simple data such as a self-introduction of the user, an opinion of the user, and a question of the user, and sentence data composed of various sentences and/or paragraphs. Further, the translation data may be composed of data obtained by direct translation from one language to another language, and more specifically, may be composed of text data translated by the user from an English sentence into Korean. Further, the summary data may be composed of data that summarizes, into one to three lines, sentence data when a large amount of text is contained, or a large number of documents and/or a large amount of text in the original data. Further, the conversational data may be composed of conversation history data exchanged with at least one or more corresponding objects among another user, a chatbot, and/or a voice assistant through an app or application. Further, the voice data may be composed of user's speech, voice, and voice response, and speech, voice, and voice response data of another user. Further, the tactile data, which is data in response to a user reaction or input to vibration, pressure, or temperature, and may be composed data obtained through an I/O interface of tactile feedback equipment (e.g., the input/output interface 140 of FIG. 1). Further, the olfactory data may be composed of a user's reaction to a smell generated by the user or a smell emitted from the outside, and/or detection data of an olfactory sensing module. Further, the input image data may be composed of image data visually recognized by the user or uploaded by the user. Further, the analysis data may be composed of data regarding statistics, charts, and determinations generated by the user through data analysis, and more specifically, may be composed of data such as Excel calculation results, interpretations of machine learning model results, and personal reviews. Further, the mathematical operation data, which is data regarding calculation expressions, formulas, and operation inputs performed by the user, may be composed of data directly related to mathematics, such as function values, calculator input values, and function graphs. Subsequently, the server 108 can input at least one of sentence data, translation data, summary data, and conversational data into a first sub-deep learning model, input at least one of input image data, analysis data, and at least one user data into a second sub-deep learning model, and input at least one of voice data, tactile data, and olfactory data into a third sub-deep learning model.

In operation 203, the server 108 (e.g., the processor 120 of FIG. 1) can determine text data regarding the user by inputting at least one user data item into the first sub-deep learning model. According to an embodiment, the server 108 can determine text data by inputting at least one of sentence data, translation data, summary data, and conversational data into the first sub-deep learning model to, and if it is determined that the text data does not exceed a preset text threshold, the server 108 can classify the text data as first text result data, and if it is determined that the text data exceeds the text threshold, the server 108 can classify the text data as second text result data. Specifically, the server 108 can verify at least one of the sentence data, translation data, summary data, and conversational data. Subsequently, the server 108 can determine text data regarding the user by inputting at least one of the verified sentence data, translation data, summary data, and conversational data into the first sub-deep learning model. Subsequently, the server 108 can determine whether the text data is first text result data composed of data for performing a simple task or second text result data composed of data requiring a complex task by comparing the text data with a preset text threshold. Further, the text threshold may be set as a reference value for comparing whether the text data is simple data within one to three lines, such as “translate ˜,” “summarize ˜,” or “draw such and such a picture,” or not. Subsequently, if the text data does not exceed the text threshold, the server 108 can determine that the text data is first text result data composed of simple data within one to three lines, such as “translate ˜,” “summarize ˜,” or “draw such and such a picture,” and if the text data exceeds the text threshold, the server 108 can determine that the text data is second text result data while being determined as data of a multi-modal query or a complex request including at least four or more lines of data and/or one to three lines but containing a large amount of data. Subsequently, the server 108 can input at least one or more of the text data, the first text result data, and/or the second text result data into a predictive model.

According to another embodiment, the first sub-deep learning model can be trained on the basis of a plurality of user data items, a plurality of sentence data items, a plurality of translation data items, a plurality of summary data items, and a plurality of conversational data items, and a plurality of text data items, a plurality of first text result data items, and a plurality of second text result data items. Specifically, the first sub-deep learning model for determining text data regarding the user may be configured with a DNN-based feed-forward network (FFN), backpropagation, and a recurrent neural network (RNN). The FFN is a neural network in which a processing proceeds in one direction from an input layer to a hidden layer and from the hidden layer to an output layer, and is the simplest and most convenient, but has the drawback that it is impossible to adjust the weights of errors. In the case of backpropagation, the result value of the output layer is returned to the input layer to be able to reduce the error of the result, the deviation of the weights is well applied, and it is a DNN modeling that is frequently used due to its relatively high learning speed. The RNN generates output nodes through intersections with hidden nodes via a context unit, without affecting the input layer and the output layer, so it can be used in a manner similar to a timeline. Further, a CNN structure has been applied to the first sub-deep learning model, and examples thereof are not limited thereto.

Further, in the present embodiment, it has been shown that the text data is input and analyzed in the first sub-deep learning model, but the text data can be distinguished independently without the first sub-deep learning model.

In operation 205, the server 108 (e.g., the processor 120 of FIG. 1) can determine image data regarding the user by inputting at least one user data item into the second sub-deep learning model. According to an embodiment, the server 108 can determine image data by inputting at least one of input image data, analysis data, and at least one user data item into the second sub-deep learning model. and if it is determined that the image data does not exceed a preset image threshold, the image data may be classified as first image result data, and if it is determined that the image data exceeds the image threshold, the image data may be classified as second image result data. Specifically, the server 108 can verify input image data and analysis data. Subsequently, the server 108 can determine image data regarding the user by inputting at least one of the verified image data and analysis data into the second sub-deep learning model. Subsequently, the server 108 can determine whether the image data is first image result data composed of data for performing a simple task or second image result data composed of data requiring a complex task by comparing the text data with a preset image threshold. Further, the image threshold may be set by comparing whether the image data contains one to three data items or not, or, when input as video data, by setting a predetermined value of a certain time (e.g., three minutes) and/or a certain size (e.g., 10 MB). Thereafter, if the image data does not exceed the image threshold, the server 108 can determine that the image data is simple image data consisting of one to three image data items, or is first image result data determined as video data having a duration of three minutes or less and/or a size of 10 NB or less. If the image data exceeds the image threshold, the server 108 can determine that the image data is second image result data for comparing whether the image data is video data included by three minutes or more and a size of 10 MB or more in at least four or more image data items and/or video data items. Subsequently, the server 108 can input at least one or more of the image data, the first image result data, and/or the second image result data into a predictive model.

According to another example, the second sub-deep learning model can be trained on the basis of a plurality of user data items, a plurality of analysis data items, and a plurality of input image data items, and a plurality of image data items, a plurality of first image result data items, and a plurality of second image result data items. Specifically, the second sub-deep learning model for determining image data may be implemented as a CNN structure, and least one of AlexNet, LeNet-5, NIN, VGGNet, ResNet, WideResNet, GoogleNet, FractaNet, DenseNet, FitNet, RitResNet, HighwayNet, MobileNet, and DeeplySupervisedNet may be used. More specifically, LeNet-5 is the most recent model among the LeNet models, was created at Yann LeCun's laboratory in the 1990s, and may be utilized for recognizing postal codes or numbers. Further, the key point is that the LeNet structure is not significantly different from the current CNN, and convolution and subsampling are used, and it can be connected through a fully connection by flattening a feature map into a single line. Subsequently, AlexNet is a model that won the ILSVRC 2012, and at that time, it can be regarded that a revolution in deep learning occurred due to the AlexNet model. This is because AlexNet having a CNN structure can significantly reduce the past top-5 error. Further, the CNN technique began to be applied to AlexNet began to be in image neural networks, and AlexNet proceeds with such a structure, wherein a distinctive point is that, instead of applying multiple filters at once, it was split into two sides to perform analysis using two GPUs. ZFNet is almost identical to the structure of AlexNet, and in fact, it only changed some of the parameters used in AlexNet, while performance is improved, and this shows that, in order to train a CNN well, it is possible to check how the filters in the intermediate layers are learned. As another example, GoogLeNet is the model that won the LSVRC 2014, and compared to AlexNet, it has greater depth and also greater width, yet it can be seen that the number of parameters has been greatly reduced. This is because, in GoogLeNet, the concept of the inception module was introduced, and since filter operations are linear operations, the inception module was applied, which was developed from the concept that more information could be found if filter operations were performed in a nonlinear manner. The structure of GoogLeNet contains layers similar to a network within the network structure, and by forming this as a Network In Network (NIN) structure, it can be made nonlinear. Further, a CNN structure has been applied to the second sub-deep learning model, and examples thereof are not limited thereto.

Further, in the present embodiment, it has been shown that the image data is analyzed by being input into the second sub-deep learning model, but the image data may be distinguished independently without the second sub-deep learning model.

In operation 207, the server 108 (e.g., the processor 120 of FIG. 1) can determine text data regarding the user by inputting at least one user data item into the third sub-deep learning model. According to an example, the server 108 can determine supplementary data for the user by inputting at least one of user data, voice data, tactile data, and olfactory data into the third sub-deep learning model, and if it is determined that the supplementary data does not exceed a predetermined supplementary threshold, the server 108 can classify the supplementary data as first supplementary result data, and if it is determined that the supplementary data exceeds the supplementary threshold, the server 108 can classify the supplementary data as second supplementary result data.

Specifically, the server 108 can verify at least one of the voice data, tactile data, and olfactory data. Subsequently, the server 108 can determine supplementary data regarding the user by inputting at least one of the verified voice data, tactile data, and olfactory data into the third sub-deep learning model. Subsequently, the server 108 can determine whether the supplementary data is first supplementary result data composed of data for performing a simple task or second supplementary result data composed of data requiring a complex task by comparing the supplementary data with a preset text threshold. Further, the supplementary threshold may be set, in the supplementary data, by comparing whether the voice data is data within one minute, by comparing whether the olfactory data corresponds to a specific scent (e.g., a human body odor) when the olfactory data is input, or by comparing whether the tactile data corresponds to a contact within a predetermined time (e.g., five seconds) and/or within a predetermined contact range (e.g., 1 cm²) when the tactile data is input. Thereafter, if the supplementary data does not exceed the supplementary threshold, the server 108 can determine the supplementary data as simple supplementary data in which the voice data is within one minute, or if the olfactory data is determined as a human body odor or as tactile data corresponding to a contact within one second and/or within 1 cm², the server 108 can determine the supplementary data as first supplementary result data. If the supplementary data exceeds the supplementary threshold, and the server 108 can determine the supplementary data as complex supplementary data in which the voice data is one minute or more, or if the olfactory data is not determined as a human body odor or is determined as tactile data corresponding to contact of one second or more and a contact width of 1 cm² or more, the server 108 can determine that the supplementary data is configured as second supplementary result data. Subsequently, the server 108 can input at least one or more of the supplementary data, the first supplementary result data, and/or the second supplementary result data into a predictive model.

According to another example, the third sub-deep learning model can be trained on the basis of a plurality of user data items, a plurality of voice data items, a plurality of tactile data items, and a plurality of olfactory data items, a plurality of supplementary data items, a plurality of first supplementary result data items, and a plurality of second supplementary result data items. Specifically, in order to determine supplementary data, the third sub-deep learning model for outputting at least one first voice feature data item may be configured as a deep learning model including, largely, a Mel-spectrogram, Mel Frequency Cepstral Coefficients (MFCC), a Wav2Vec model, and a HuBERT model structure. Here, the third sub-deep learning model may include Mel-spectrogram and MFCC, which are most useful for converting the characteristics of voice data into an input format, which models can understand, by quantifying them. First, the Mel-spectrogram used in the third sub-deep learning model may be one that is converted into a mel scale adapted to the user's auditory sense on the basis of a spectrogram in which voice data is converted into the relationship between time and frequency. In relation to this, the processing of the Mel-spectrogram can divide at least one voice data item into small sections (frames) by splitting continuous data at fixed time intervals, and can smoothly connect the divided frames by processing them through a method such as a Hamming window, and can convert the time-domain data into the frequency domain by performing a Short-Time Fourier Transform (STFT) on each frame, thereby being able to output them in the form of a spectrogram. Thereafter, since the Mel-spectrogram is sensitive to low frequencies and less sensitive to high frequencies, the frequency axis of the spectrogram can be nonlinearly transformed using a Mel-scale filter, the frequency bands can be readjusted on the basis of the log scale that reflects the magnitude perception of human hearing, by converting the amplitude values of the spectrogram into a log scale, and finally, a Mel-spectrogram in the form of 2D data containing time and Mel frequency components can be generated. Such characteristics of the Mel-spectrogram can provide high-resolution frequency information and have the advantage of being usable as a visual representation for at least one voice data item. In addition, the MFCC that is used in the third sub-deep learning model is a variant of the Mel-spectrogram, and can extract a small-scale feature vector, which is suitable as an input to models, by further compressing the frequency information of the voice data. The processing of the MFCC may be performed after completing the process of the Mel-spectrogram, and can convert the log values of the Mel-filtered spectrogram through Discrete Cosine Transform (DCT), which emphasizes the most important information (low-frequency components) and removes unnecessary high frequencies, by summarizing the frequency components on the basis of the density of energy, and can greatly reduce the data size while preserving the basic sound quality of the voice data by selecting several of the most important coefficients (typically 12 to 13) from the DCT result. Thereafter, the MFCC can capture more dynamic information by adding changes over the time axis (delta) and changes in the rate of change (delta-delta). Such characteristics of the MFCC may be advantageous for real-time processing due to its small data size and low computational cost, and have the advantage of well preserving the core acoustic features of the voice data. Further, the third sub-deep learning model may include a Wav2Vec model and a HuBERT model. More specifically, the Wav2Vec model and the HuBERT model included in the third sub-deep learning model, which are deep learning-based models that play an important role in natural language processing and voice data recognition technologies for processing and analyzing voice data, can be utilized for various voice data processing tasks by learning useful representations from voice data. Further, the Wav2Vec model included in the configuration of the third sub-deep learning model was developed by Facebook AI Research (FAIR), can receive voice data as input and convert it into continuous latent representations, can extract features from the voice data using Convolutional Neural Networks (CNNs), and can learn linguistic patterns from the extracted features using a Transformer. Further, the Wav2Vec model included in the configuration of the third sub-deep learning model can use a self-supervised learning method, can be trained to mask a portion of voice data and predict it, and has the advantage that it can be efficiently trained by utilizing large-scale unlabeled voice data.

Further, the Wav2Vec model included in the configuration of the third sub-deep learning model can achieve excellent performance with a small amount of labeled data, can recognize multilingual voice data by learning voice data of various languages, can analyze emotions in voice data or extract specific timbre and tone characteristics, and can be utilized for transfer learning in various tasks such as voice data generation and speaker identification. Further, the HuBERT model included in the configuration of the third sub-deep learning model was developed by Facebook AI Research as a successor to Wav2Vec, employs a CNN and Transformer architecture similar to Wav2Vec, and can learn linguistic information through a Transformer after extracting features of voice data. Specifically, the HuBERT model included in the configuration of the third sub-deep learning model, as can be inferred from the name Hidden Unit BERT (HuBERT), can be used in BERT-style self-supervised learning, can generate potential labels (hidden units) by clustering voice data, and have the advantage that it can learn more sophisticated voice data representations by training itself on the basis of the clustered labels. Further, the HuBERT model included in the configuration of the third sub-deep learning model is distinct from previous models in that it has a unique feature of generating arbitrary labels by clustering the signal itself during a training process, and can learn progressively better representations through multiple stages. Further, the HuBERT model included in the configuration of the third sub-deep learning model can learn richer and more sophisticated voice data representations in comparison to Wav2Vec, can receive voice data as input and translate it into another language or convert it into text, can perform multimodal tasks integrating voice data, olfactory data, and/or tactile data, and can maximize performance by utilizing a small amount of labeled data in a data-scarce environment. In conclusion, the server 108 according to the present embodiment can easily output supplementary data by inputting at least one voice data item into the third sub-deep learning model composed of various voice data conversion models. Thereafter, the server 108 can input the supplementary data into a predictive model.

Further, in the present embodiment, it has been shown that the supplementary data is input and analyzed in the third sub-deep learning model, but the supplementary data may be distinguished independently without the third sub-deep learning model.

In operation 209, the server 108 (e.g., the processor 120 of FIG. 1) can determine a customized model for the user by inputting at least one or more of text data, image data, and/or supplementary data into a predictive model. According to an embodiment, the predictive model can be trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors. Further, the predictive model can be trained additionally on the basis a plurality of supplementary data items, a plurality of first text result data items, a plurality of second text result data items, a plurality of first image result data items, a plurality of second image result data items, a plurality of first supplementary result data items, and a plurality of second supplementary result data items, in addition to a plurality of total loss functions, a plurality of quality loss functions, a plurality of cost loss functions, and a plurality of efficiency loss functions. Specifically, the predictive model for determining a customized model for the user may be operated as an AI neural network model trained through unsupervised learning on the basis of base data. The predictive model may be configured to facilitate data collection and to generate output values for various types of data. The predictive model may have a structure in which text data is output as image data, and at least one of bloom and T0pp of BigScience, the GPT series of EleutherAI, the GLM series of Tsinghua University, the UL and T5 series of Google, and the OPT series of META AI may be used. According to an example, the predictive model is used as a plurality of cloud foundation models and can be implemented using the architectures of Microsoft's ChatGPT, Google's BARD series, and the NVIDIA's translation service-based transformer model. For example, the predictive model may be trained as a multimodal model on the basis of at least one of text data, image data, and audio data, thereby being able to implement various visualizations. In an embodiment, this can reduce the amount of task-specific labeled training data compared to existing deep learning methods, and, once built, can be trained in various ways with a small amount of training data, so it is easy to collect data and designate labels, and the accuracy can be improved. Further, the server 108 may perform, as a training process of the predictive model for outputting state prediction data, obtains a result value (output data) using the predictive model with arbitrary weights assigned, compares the obtained result value with labeling data of training data, and performs backpropagation in accordance with an error, thereby being able to optimize the weights. Specifically, the training of the predictive model refers to a process of training the predictive model on the basis of training data and labeling data or unlabeled data so that the predictive model can determine output data with respect to input data. That is, the predictive model establishes rules with respect to the data and determines outcomes. According to an embodiment, the server 10) can use a plurality of learning algorithms, among a plurality of learning algorithms for calculating a predicted value. For example, an ensemble method may be used in the predictive model, and better prediction performance can be obtained compared to using learning algorithms separately. The term “training a predictive model” may refer to adjusting the weights of the model. According to an embodiment, as a learning method, various methods such as supervised learning, unsupervised learning, reinforcement learning, imitation learning, and federated learning can be used.

Although not illustrated, the server 108 may include an evaluation step of evaluating the performance of the predictive model in a process of training the predictive model. In the evaluation step, the predictive model can be evaluated using an evaluation data set. The evaluation of the predictive model may be a step of evaluating the predictive model trained by the training step and predicting new data using the predictive model. Specifically, the evaluation step may be a step of measuring whether the trained predictive model is capable of generalizing to new data.

Further, the predictive model is a type of artificial neural network, in the form of a long short-term memory (LSTM) structure, specialized in learning patterns from time-series or sequential data, and mainly in the form of an improved recurrent neural network (RNN) structure. While an RNN is a structure that predicts the future on the basis of past information, it has a gradient vanishing problem that makes it difficult to learn from long sequences, thereby having difficulty in processing long-term dependencies. However, the predictive model (LSTM) can learn long-term dependencies by controlling the flow of information by introducing a special gate structure in order to solve this problem. The predictive model can operate in a manner of selectively remembering and forgetting information using three gates including an input gate, a forget gate, and an output gate, and these gates can perform the following at each time step. First, the input gate can determine how much of the newly input information to accept, the forget gate can determine how much of the previously stored information to forget, and the output gate can determine the amount of information to deliver next from the current state. On the basis of the above three gates, the predictive model can learn autonomously and control whether past information is necessary for the current prediction, and can know through learning whether the information at the beginning of a sentence is necessary at the end of the sentence. In addition, the predictive model (LSTM) particularly has an advantage in being able to grasp the overall context of a sentence in machine translation by processing natural language such as sentence generation, translation, and sentiment analysis, can recognize specific words or phrases by processing voice data in time series, can be used to predict future stock prices by learning past stock price fluctuation patterns, can learn changes between frames over time in a video and use them for action prediction or scene classification, and can analyze a user's past medical history and medical records and use them for long-term prediction, for example, predicting the probability of disease onset. Further, the predictive model (LSTM) has an advantage in being able to remember and utilize past data well even when it is long. However, the predictive model (LSTM) has a high computational cost, and when the amount of data increases, the training time may become longer, so that as other sequential models such as a gated recurrent unit (GRU) or a transformer model have emerged, it may include a structure that is selectively used in various situations to overcome this.

According to another embodiment, the server 108, as illustrated in FIG. 3A AND FIG. 3B AND FIG. 3C, can generate a first quality loss function, a first cost loss function, a first efficiency loss function, and a first total loss function for text data by inputting the text data into a predictive model based on the following Equation 1.

$$\begin{matrix}[ Equation 1 ] & \\ \begin{matrix}L = w 1 \cdot {L}_{quality} + w 2 \cdot {L}_{cost} + w 3 \cdot {L}_{effciency} & ( w 1 + w 2 + w 3 = 1 )\end{matrix} & ( 1 )\end{matrix}$$

$$\begin{matrix}{L}_{quality} = {β}_{1} \cdot {L}_{accuracy} + {β}_{2} \cdot {L}_{completeness} & ( {β}_{1} + {β}_{2} = 1 )\end{matrix} \qquad ( 2 )$$

$${\begin{matrix}{L}_{cost} = {δ}_{1} \cdot {L}_{token} + {δ}_{2} \cdot {L}_{overhead} & ( {δ}_{1} + δ\end{matrix}}_{2} = 1 ) \qquad ( 3 )$$

$$\begin{matrix}{L}_{effciency} = {y}_{1} \cdot {L}_{time} + {y}_{2} \cdot {L}_{computation} & ( {y}_{1} + {y}_{2} = 1 )\end{matrix} \qquad ( 4 )$$

where L denotes a first total loss function, L_{quality} denotes a first quality loss function, L_{cost} denotes a first cost loss function, L_{efficiency} denotes a first efficiency loss function, w1, w2, w3 denote respective weights for the first quality loss function, the first cost loss function, and the first efficiency loss function, L_{accuracy} denotes a value obtained by dividing a correct score for a domain, L_{completeness} denotes a completeness score value for a domain, β₁, β₂ denote weight values for calculating the first quality loss function, Lₜₒₖₑₙ denotes a calculated value for tokens relative to price, L_{overhead} denotes a first cost total value excluding price, δ₁, δ₂ denote weight values for calculating the first cost loss function, Lₜᵢₘₑ denotes a ratio value for actual processing time, L_{computation} denotes a ratio value for the number of tokens used, and y₁, y₂ denote weight values for calculating the first efficiency loss function.

Specifically, when the server 108 confirms that only the text data among text data, image data, and supplementary data is input to the predictive model or that the text data is input to the predictive model from multiple data, a first quality loss function, which is a quality loss function for the text data, can be output, a first cost loss function, which is a cost loss function for the text data, can be output, and a first efficiency loss function, which is an efficiency loss function for the text data, can be output so that the output customized model can be accurately provided. Further, the first quality loss function can be checked by inputting, into the predictive model, whether it is similar to or better than the first text result data or the second text result data, the first cost loss function can be compared in the predictive model to determine whether there is an increase or decrease in cost in comparison with the first text result data or the second text result data, and the first efficiency loss function can be configured as a value that can be checked, into the predictive model, by inputting whether it is the most efficient in terms of the final response output time in the second text result data. Further, the server 108 can determine that the model is the best user-customized model when the first quality loss function output from the predictive model is 95% similar, the first cost loss function is at least 90% cheaper than other models, and the first efficiency loss function shows the same case relative to the total required time. Further, the server 108 can output that the model is a customized model that has partial errors but is adoptable, when the first quality loss function output from the predictive model is 90% similar, the first cost loss function indicates at least a 50% cost reduction compared to other models, and the first efficiency loss function indicates a 10% error relative to the total required time.

According to another embodiment, the server 108, as illustrated in FIG. 3A AND FIG. 3B AND FIG. 3C, can generate a second quality loss function, a second cost loss function, a second efficiency loss function, and a second total loss function for the text data for image data by inputting the image data into a predictive model based on the following Equation 2.

$$\begin{matrix}[ Equation 2 ] & \\ \begin{matrix}L = w 1 \cdot {L}_{quality} + w 2 \cdot {L}_{cost} + w 3 \cdot {L}_{effciency} & ( w 1 + w 2 + w 3 = 1 )\end{matrix} & ( 1 )\end{matrix}$$

$$\begin{matrix}{L}_{quality} = {β}_{1} \cdot {L}_{accuracy} + {β}_{2} \cdot {L}_{completeness} & ( {β}_{1} + {β}_{2} = 1 )\end{matrix} \qquad ( 2 )$$

$${\begin{matrix}{L}_{cost} = {δ}_{1} \cdot {L}_{token} + {δ}_{2} \cdot {L}_{overhead} & ( {δ}_{1} + δ\end{matrix}}_{2} = 1 ) \qquad ( 3 )$$

$$\begin{matrix}{L}_{effciency} = {y}_{1} \cdot {L}_{time} + {y}_{2} \cdot {L}_{computation} & ( {y}_{1} + {y}_{2} = 1 )\end{matrix} \qquad ( 4 )$$

where L denotes a second total loss function, L_{quality} denotes a second quality loss function, L_{cost} denotes a second cost loss function, L_{efficiency} denotes a second efficiency loss function, w1, w2, w3 denote respective weights for the second quality loss function, the second cost loss function, and the second efficiency loss function, L_{accuracy} denotes a value obtained by dividing a correct score for a domain, L_{completeness} denotes a completeness score value for a domain, β₁, β₂ denote weight values for calculating the second quality loss function, Lₜₒₖₑₙ denotes a calculated value for tokens relative to price, L_{overhead} denotes a second cost total value excluding price, δ₁, δ₂ denote weight values for calculating the second cost loss function, Lₜᵢₘₑ denotes a ratio value for actual processing time, L_{computation} denotes a ratio value for the number of tokens used, and y₁, y₂ denote weight values for calculating the second efficiency loss function.

Specifically, when the server 108 confirms that only the image data among text data, image data, and supplementary data is input to the predictive model or that the image data is input to the predictive model from multiple data, a second quality loss function, which is a quality loss function for the image data, can be output, a second cost loss function, which is a cost loss function for the image data, can be output, and a second efficiency loss function, which is an efficiency loss function for the image data, can be output so that the output customized model can be accurately provided. Further, the second quality loss function can be checked by inputting, into the predictive model, whether it is similar to or better than the first image result data or the second image result data, the second cost loss function can be compared in the predictive model to determine whether there is an increase or decrease in cost in comparison with the first image result data or the second image result data, and the second efficiency loss function can be configured as a value that can be checked, into the predictive model, by inputting whether it is the most efficient in terms of the final response output time in the second image result data. Further, the server 108 can determine that the model is the best user-customized model when the second quality loss function output from the predictive model is 95% similar, the second cost loss function is at least 90% cheaper than other models, and the second efficiency loss function shows the same case relative to the total required time. Further, the server 108 can output that the model is a customized model that has partial errors but is adoptable, when the second quality loss function output from the predictive model is 90% similar, the second cost loss function indicates at least a 50% cost reduction compared to other models, and the second efficiency loss function indicates a 10% error relative to the total required time.

According to another embodiment, the server 108, as illustrated in FIG. 3A AND FIG. 3B AND FIG. 3C, can generate a third quality loss function, a third cost loss function, a third efficiency loss function, and a third total loss function for supplementary data by inputting the supplementary data into a predictive model based on the following Equation 3.

$$\begin{matrix}[ Equation 3 ] & \\ \begin{matrix}L = w 1 \cdot {L}_{quality} + w 2 \cdot {L}_{cost} + w 3 \cdot {L}_{effciency} & ( w 1 + w 2 + w 3 = 1 )\end{matrix} & ( 1 )\end{matrix}$$

$$\begin{matrix}{L}_{quality} = {β}_{1} \cdot {L}_{accuracy} + {β}_{2} \cdot {L}_{completeness} & ( {β}_{1} + {β}_{2} = 1 )\end{matrix} \qquad ( 2 )$$

$${\begin{matrix}{L}_{cost} = {δ}_{1} \cdot {L}_{token} + {δ}_{2} \cdot {L}_{overhead} & ( {δ}_{1} + δ\end{matrix}}_{2} = 1 ) \qquad ( 3 )$$

$$\begin{matrix}{L}_{effciency} = {y}_{1} \cdot {L}_{time} + {y}_{2} \cdot {L}_{computation} & ( {y}_{1} + {y}_{2} = 1 )\end{matrix} \qquad ( 4 )$$

where L denotes a third total loss function, L_{quality} denotes a third quality loss function, L_{cost} denotes a third cost loss function, L_{efficiency} denotes a third efficiency loss function, w1, w2, w3 denote respective weights for the third quality loss function, the third cost loss function, and the third efficiency loss function, L_{accuracy} denotes a value obtained by dividing a correct score for a domain, L_{completeness} denotes a completeness score value for a domain, β₁, β₂ denote weight values for calculating the third quality loss function, Lₜₒₖₑₙ denotes a calculated value for tokens relative to price, L_{overhead} denotes a third cost total value excluding price, δ₁, δ₂ denote weight values for calculating the third cost loss function, Lₜᵢₘₑ denotes a ratio value for actual processing time, L_{computation} denotes a ratio value for the number of tokens used, and y₁, y₂ denote weight values for calculating the third efficiency loss function.

Specifically, when the server 108 confirms that only the supplementary data among text data, image data, and supplementary data is input to the predictive model or that the supplementary data is input to the predictive model from multiple data, a third quality loss function, which is a quality loss function for the supplementary data, can be output, a third cost loss function, which is a cost loss function for the supplementary data, can be output, and a third efficiency loss function, which is an efficiency loss function for the supplementary data, can be output so that the output customized model can be accurately provided. Further, the third quality loss function can be checked by inputting, into the predictive model, whether it is similar to or better than the first supplementary result data or the second supplementary result data, the third cost loss function can be compared in the predictive model to determine whether there is an increase or decrease in cost in comparison with the first supplementary result data or the second supplementary result data, and the third efficiency loss function can be configured as a value that can be checked, into the predictive model, by inputting whether it is the most efficient in terms of the final response output time in the second supplementary result data. Further, the server 108 can determine that the model is the best user-customized model when the third quality loss function output from the predictive model is 95% similar, the third cost loss function is at least 90% cheaper than other models, and the third efficiency loss function shows the same case relative to the total required time. Further, the server 108 can output that the model is a customized model that has partial errors but is adoptable, when the third quality loss function output from the predictive model is 90% similar, the third cost loss function indicates at least a 50% cost reduction compared to other models, and the third efficiency loss function indicates a 10% error relative to the total required time.

In operation 211, the server 108 (e.g., the processor 120 of FIG. 1) can determine whether the customized model exceeds a preset first threshold. According to an embodiment, the server 108 can output quality data, cost data, and efficiency data, each in a range from 0 to 1, for checking whether it is a customized model, in order to determine whether the user-customized determined by the predictive model exceeds a preset first threshold. In the present embodiment, a value determined on the basis of whether the customized model is functionally efficient or cost-sensitive may be set as a reference value for the server 108 to preferentially perform a routing technique. Further, the first threshold may be set as a reference value which, when functionality is prioritized in accordance with an administrator's setting, has a quality similarity of 98% or more compared to a single model, a cost reduction of 70% or more, and maintains −20% relative to time consumption, and which, when cost is prioritized, has a quality similarity of 90% or more compared to a single model, a cost reduction of 85% or more, and is set within −10% to 0% relative to time consumption in accordance with user convenience. Thereafter, the server 108 can check whether it is functional or cost-related, and can compare the quality data, the cost data, and the efficiency data with the first threshold set in accordance with the corresponding function.

In operation 213, the server 108 (e.g., the processor 120 of FIG. 1) can determine that the customized model is a user-customized model when it is determined that the customized model has not exceeded the first threshold. According to an embodiment, when the server 108 identifies, in a case where functionality is prioritized, that the identical percentage value of the quality data is 99.1%, the cost reduction value of the cost data is 78.4%, and the time consumption of the efficiency data is increased to −24.1%, the server 108 can determine that the functionality-prioritized first threshold (e.g., quality data=98%, cost data=70%, efficiency data=−20%) is not exceeded. Further, according to an embodiment, when the server 108 identifies, in a case where cost is prioritized, that the identical percentage value of the quality data is 91.6%, the cost reduction value of the cost data is 87.9%, and the time consumption of the efficiency data is increased to −15.1%, the server 108 can determine that the cost-prioritized first threshold (e.g., quality data=90%, cost data=85%, efficiency data=0%) is not exceeded. Thereafter, the server 108 can determine that the customized model determined by the predictive model is the most suitable model for the user.

Meanwhile, in operation 211, when the server 108 (e.g., the processor 120 of FIG. 1) determines that the customized model exceeds the first threshold, in operation 215, the server 108 (e.g., the processor 120 of FIG. 1) can compare the customized model with a second threshold set greater than the first threshold. According to an embodiment, when the server 108 identifies, in a case where functionality is prioritized, that the identical percentage value of the quality data is 95.7%, the cost reduction value of the cost data is 76.4%, and the time consumption of the efficiency data is increased to −21.1%, the server 108 determined that the cost data and the efficiency data are not exceeded in the functionality-prioritized first threshold (e.g., quality data=98%, cost data=70%, efficiency data=−20%), but can determine that the quality data is exceeded. Further, according to an embodiment, when the server 108 identifies, in a case where cost is prioritized, that the identical percentage value of the quality data is 90.6%, the cost reduction value of the cost data is 79.2%, and the time consumption of the efficiency data is increased to −15.1%, the server 108 determined that the quality data and the efficiency data are not exceeded in the cost-prioritized first threshold (e.g., quality data=90%, cost data=85%, efficiency data=0%), but can determine that the cost data is exceeded. Thereafter, the server 108 can compare the quality data, the cost data, and the efficiency data for the customized model with the second threshold set to be greater than the first threshold. Further, the second threshold may be set as a reference value which, when functionality is prioritized in accordance with an administrator's setting, has a quality similarity of 95% or more compared to a single model, a cost reduction of 60% or more, and maintains −10% relative to time consumption, and which, when cost is prioritized, has a quality similarity of 80% or more compared to a single model, a cost reduction of 70% or more, and is set within 0% to 10% relative to time consumption in accordance with user convenience. Thereafter, the server 108 can check whether it is functional or cost-related, and can compare the quality data, the cost data, and the efficiency data with the second threshold set in accordance with the corresponding function.

In operation 217, the server 108 (e.g., the processor 120 of FIG. 1) can determine that the customized model has partial errors when it is determined that the customized model exceeds the first threshold but does not exceed the second threshold. According to an embodiment, when the server 108 identifies, in a case where functionality is prioritized, that the identical percentage value of the quality data is 95.7%, the cost reduction value of the cost data is 76.4%, and the time consumption of the efficiency data is increased to −11.1%, the server 108 determined that the cost data is not exceeded in the functionality-prioritized first threshold (e.g., quality data=98%, cost data=70%, efficiency data=−20%), but can determine that the quality data and the efficiency data exceed the first threshold and do not exceeded the functionality-prioritized second threshold (e.g., quality data=95%, cost data=60%, efficiency data=−10%). According to an embodiment, when the server 108 identifies, in a case where cost is prioritized, that the identical percentage value of the quality data is 89.6%, the cost reduction value of the cost data is 79.2%, and the time consumption of the efficiency data is increased to −5.1%, the server 108 determined that the efficient data is not exceeded in the cost-prioritized first threshold (e.g., quality data=90%, cost data=85%, efficiency data=0%), but can determine that the quality data and the cost data exceed the first threshold and do not exceed the cost-prioritized second threshold (e.g., quality data=80%, cost data=70%, efficiency data=10%). Thereafter, the server 108 can determine that the customized model determined by the predictive model is a model that includes partial errors or has slightly reduced functionality but is available for the user.

Meanwhile, in operation 215, when the server 108 (e.g., the processor 120 of FIG. 1) determines that the customized model exceeds the first threshold and the second threshold, in operation 219, the server 108 (e.g., the processor 120 of FIG. 1) can determine that the error of the customized model are very serious. According to an embodiment, when the server 108 identifies, in a case where functionality is prioritized, that the identical percentage value of the quality data is 95.7%, the cost reduction value of the cost data is 56.4%, and the time consumption of the efficiency data is increased to 0.24%, the server 108 can determine that all data are exceeded in the functionality-prioritized first threshold (e.g., quality data=98%, cost data=70%, efficiency data=−20%), and determined that the quality data is not exceeded in the functionality-prioritized second threshold (e.g., quality data=95%, cost data=60%, efficiency data=−10%), but can determine that the cost data and the efficiency data exceed the second threshold. According to an embodiment, when the server 108 identifies, in a case where cost is prioritized, that the identical percentage value of the quality data is 74.6%, the cost reduction value of the cost data is 71.2%, and the time consumption of the efficiency data is increased to 0.89%, the server 108 can determine that all data in the cost-prioritized first threshold (e.g., quality data=90%, cost data=85%, efficiency data=0%) exceed the first threshold, and determined that the cost data and the efficiency data are not exceeded in the cost-prioritized second threshold (e.g., quality data=80%, cost data=70%, efficiency data=10%), but can determine that the quality data exceeds the second threshold. Thereafter, the server 108 can determine that the error of the customized model exceeding the first threshold and the second threshold is very serious, and can repeatedly perform the process until the first threshold and/or the second threshold are not exceeded by returning to operation 203 and retraining the predictive model only when the customized model is equal to or greater than the first threshold and the second threshold.

In operation 221, the server 108 (e.g., the processor 120 of FIG. 1) can transmit the customized model, only for the customized model determined in operation 213 and/or operation 217, to the user's external electronic devices 101, 102, 104, and 106 through the communication interface (e.g., the communication interface 160 of FIG. 1). According to an embodiment, the server 108 can provide or recommend the customized model, which does not exceed the first threshold and/or the second threshold, to the user's external electronic devices 101, 102, 104, and 106. Thereafter, the user can check, on the display of the user's external electronic devices 101, 102, 104, and 106, that the customized model is in use or is to be used.

According to the present embodiment, the server 108 has the advantage that it can easily perform an analysis on each data by preprocessing at least one user data item acquired from the user's external electronic devices 101, 102, and 104, and 106, can extract a customized model according to the selection by using a loss function output by inputting the analysis data into a predictive model, can determine whether the customized model is suitable, and can provide the customized model to the user.

According to various embodiments, a server for recommending a customized model based on a predictive model includes:
a communication interface; and
a processor,
wherein the processor is configured to:
receive at least one user data item from an external electronic device of the user through the communication interface;
determine text data for the user by inputting the at least one user data item into a first sub-deep learning model;
determine image data for the user by inputting the at least one user data item into a second sub-deep learning model;
determine a customized model for the user by inputting at least one or more of the text data and/or the image data into the predictive model; and
transmit the customized model to the external electronic device of the user through the communication interface,
wherein the predictive model is trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors.

According to various embodiments, the at least one user data item includes sentence data created by the user, translation data created by the user, summary data created by the user, conversational data created by the user, voice data sensed or produced by the user, tactile data sensed or produced by the user, olfactory data sensed or produced by the user, input image data visually confirmed by the user or input by the user, analysis data of the user, and mathematical operation data of the user.

According to various embodiments, the processor is configured to:
determine the text data by inputting at least one of the sentence data, the translation data, the summary data, and the conversational data into the first sub-deep learning model;
classify the text data as first text result data when it is determined that the text data does not exceed a preset text threshold; and
classify the text data as second text result data when it is determined that the text data exceeds the text threshold,
wherein the first sub-deep learning model is trained on the basis of a plurality of user data items, a plurality of sentence data items, a plurality of translation data items, a plurality of summary data items, and a plurality of conversational data items, and a plurality of text data items, a plurality of first text result data items, and a plurality of second text result data items.

According to various embodiments, the processor is configured to:
determine the image data by inputting at least one of the input image data, the analysis data, and the at least one user data item into the second sub-deep learning model;
classify the image data as first image result data when it is determined that the image data does not exceed a preset image threshold; and
classify the image data as second image result data when it is determined that the image data exceeds the image threshold,
wherein the second sub-deep learning model is trained on the basis of a plurality of user data items, a plurality of analysis data items, and a plurality of input image data items, and a plurality of image data items, a plurality of first image result data items, and a plurality of second image result data items.

According to various embodiments, the processor is configured to:
determine supplementary data for the user by inputting at least one of the at least one user data item, the voice data, the tactile data, and the olfactory data into a third sub-deep learning model;
classify the supplementary data as first supplementary result data when it is determined that the supplementary data does not exceed a preset supplementary threshold; and
classify the supplementary data as second supplementary result data when it is determined that the supplementary data exceeds the supplementary threshold,
wherein the third sub-deep learning model is trained on the basis of a plurality of user data items, a plurality of voice data items, a plurality of tactile data items, and a plurality of olfactory data items, a plurality of supplementary data items, a plurality of first supplementary result data items, and a plurality of second supplementary result data items.

According to various embodiments, the processor is configured to:
generate a first quality loss function, a first cost loss function, a first efficiency loss function, and a first total loss function for the text data by inputting the text data into the predictive model based on the following [Equation 1];
generate a second quality loss function, a second cost loss function, a second efficiency loss function, and a second total loss function for the image data by inputting the image data into the predictive model based on the following [Equation 1]; and
generate a third quality loss function, a third cost loss function, a third efficiency loss function, and a third total loss function for the supplementary data by inputting the supplementary data into the predictive model based on the following [Equation 1],

$$\begin{matrix}[ Equation 1 ] & \\ \begin{matrix}L = w 1 \cdot {L}_{quality} + w 2 \cdot {L}_{cost} + w 3 \cdot {L}_{effciency} & ( w 1 + w 2 + w 3 = 1 )\end{matrix} & ( 1 )\end{matrix}$$

$$\begin{matrix}{L}_{quality} = {β}_{1} \cdot {L}_{accuracy} + {β}_{2} \cdot {L}_{completeness} & ( {β}_{1} + {β}_{2} = 1 )\end{matrix} \qquad ( 2 )$$

$${\begin{matrix}{L}_{cost} = {δ}_{1} \cdot {L}_{token} + {δ}_{2} \cdot {L}_{overhead} & ( {δ}_{1} + δ\end{matrix}}_{2} = 1 ) \qquad ( 3 )$$

$$\begin{matrix}{L}_{effciency} = {y}_{1} \cdot {L}_{time} + {y}_{2} \cdot {L}_{computation} & ( {y}_{1} + {y}_{2} = 1 )\end{matrix} \qquad ( 4 )$$

where L denotes the first total loss function, the second total loss function, and the third total loss function, L_{quality} denotes the first quality loss function, the second quality loss function, and the third quality loss function, L_{cost} denotes the first cost loss function, the second cost loss function, and the third cost loss function, L_{efficiency} denotes the first efficiency loss function, the second efficiency loss function, and the third efficiency loss function, w1, w2, w3 denote respective weights for the quality loss function, the cost loss function, and the efficiency loss function, L_{accuracy} denotes a value obtained by dividing a correct score for a domain, L_{completeness} denotes a completeness score value for a domain, β₁, β₂ denote weight values for calculating the quality loss function, Lₜₒₖₑₙ denotes a calculated value for tokens relative to price, L_{overjead} denotes a cost total value excluding price, δ₁, δ₂ denote weight values for calculating the cost loss function, Lₜᵢₘₑ denotes a ratio value for actual processing time, L_{computation} denotes a ratio value for the number of tokens used, and y₁, y₂ denote weight values for calculating the efficiency loss function.

According to various embodiments, the predictive model is trained additionally on the basis a plurality of supplementary data items, a plurality of first text result data items, a plurality of second text result data items, a plurality of first image result data items, a plurality of second image result data items, a plurality of first supplementary result data items, and a plurality of second supplementary result data items, in addition to a plurality of total loss functions, a plurality of quality loss functions, a plurality of cost loss functions, and a plurality of efficiency loss functions.

According to various embodiments, the processor is configured to determine that the customized model is a user-customized model when the customized model is equal to or less than a preset first model threshold, and to determine that the customized model has partial errors when the customized model is equal to or greater than the first threshold but equal to or less than a second threshold set greater than the first threshold.

According to various embodiments, the processor is configured to: determine that the customized model has very serious errors when the customized model is greater than or equal to the first threshold and the second threshold and retrain the customized model in the predictive model only when the customized model is greater than or equal to the first threshold and the second threshold; and transmit the customized model to the external electronic device of the user only when the customized model does not exceeded the second threshold.

Further, according to other various embodiments, a method of operating a server for recommending a customized model based on a predictive model is configured to: receive at least one user data item from an external electronic device of the user through the communication interface; determine text data for the user by inputting the at least one user data item into a first sub-deep learning model through a processor; determine image data for the user by inputting the at least one user data item into a second sub-deep learning model through the processor; determine a customized model for the user by inputting at least one or more of the text data and/or the image data into the predictive model through the processor; and transmit the customized model to the external electronic device of the user through the communication interface, wherein the predictive model is trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors.

The term “module” or “unit” used herein may include a unit implemented as hardware, software, or firmware, and for example, may be mutually used with terms such as a logic, a logical block, a part, or a circuit. The “module” or “˜ unit” may be an integrated part, or the minimum unit or a portion that performs one or more functions. The “module” or “˜ unit” may be mechanically or electronically implemented, and for example, may include an application-specific integrated circuit (ASIC) chip, field-programmable gate arrays (FPGAs), or a programmable logic deice that has been known or will be developed and performs some operations, and may be executed by the processor 120. At least a portion of a device (e.g., modules or functions thereof) or a method (e.g., operations) according to various embodiments may be implemented by instructions stored in a computer-readable storage medium (e.g., memory 130) in the form of program modules. When the instructions are executed by a processor (e.g., the processor 120), the processor can perform functions corresponding to the instructions. The computer-readable recording medium may include a hard disk, a floppy disk, a magnetic medium (e.g., a magnetic tape), an optical recording medium (e.g., a CD-ROM and a DVD), a magnet-optical medium (e.g., a floptical disk), a built-in memory, etc. Instructions may include codes constructed by a compiler or codes that can be executed by an interpreter. Modules or program modules according to various embodiments may include at least one or more of the components described above, may be partially omitted, or may further include other components. Operations that are performed by modules, program modules, or other components according to various embodiments may be performed sequentially, in parallel, repeatedly, or heuristically, or at least some operation may be performed in another order or omitted, or other operations may be added.

Further, embodiments described herein are proposed to explain and help understand the disclosure and do not limit the scope of the disclosure. Accordingly, the scope of the disclosure should be construed as including all changes based on the spirit of the disclosure or other various embodiments.

What is claimed is:

1. A server for recommending a customized model based on a predictive model, the server comprising:
a communication interface; and
a processor,
wherein the processor is configured to:
receive at least one user data item from an external electronic device of the user through the communication interface;
determine text data for the user by inputting the at least one user data item into a first sub-deep learning model;
determine image data for the user by inputting the at least one user data item into a second sub-deep learning model;
determine a customized model for the user by inputting at least one or more of the text data and/or the image data into the predictive model; and
transmit the customized model to the external electronic device of the user through the communication interface,
wherein the predictive model is trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors.

2. The server of claim 1, wherein the at least one user data item includes sentence data created by the user, translation data created by the user, summary data created by the user, conversational data created by the user, voice data sensed or produced by the user, tactile data sensed or produced by the user, olfactory data sensed or produced by the user, input image data visually confirmed by the user or input by the user, analysis data of the user, and mathematical operation data of the user.

3. The server of claim 2, wherein the processor is configured to:
determine the text data by inputting at least one of the sentence data, the translation data, the summary data, and the conversational data into the first sub-deep learning model;
classify the text data as first text result data when it is determined that the text data does not exceed a preset text threshold; and
classify the text data as second text result data when it is determined that the text data exceeds the text threshold,
wherein the first sub-deep learning model is trained on the basis of a plurality of user data items, a plurality of sentence data items, a plurality of translation data items, a plurality of summary data items, and a plurality of conversational data items, and a plurality of text data items, a plurality of first text result data items, and a plurality of second text result data items.

4. The server of claim 3, wherein the processor is configured to:
determine the image data by inputting at least one of the input image data, the analysis data, and the at least one user data item into the second sub-deep learning model;
classify the image data as first image result data when it is determined that the image data does not exceed a preset image threshold; and
classify the image data as second image result data when it is determined that the image data exceeds the image threshold,
wherein the second sub-deep learning model is trained on the basis of a plurality of user data items, a plurality of analysis data items, and a plurality of input image data items, and a plurality of image data items, a plurality of first image result data items, and a plurality of second image result data items.

5. The server of claim 4, wherein the processor is configured to:
determine supplementary data for the user by inputting at least one of the at least one user data item, the voice data, the tactile data, and the olfactory data into a third sub-deep learning model;
classify the supplementary data as first supplementary result data when it is determined that the supplementary data does not exceed a preset supplementary threshold; and
classify the supplementary data as second supplementary result data when it is determined that the supplementary data exceeds the supplementary threshold,
wherein the third sub-deep learning model is trained on the basis of a plurality of user data items, a plurality of voice data items, a plurality of tactile data items, and a plurality of olfactory data items, a plurality of supplementary data items, a plurality of first supplementary result data items, and a plurality of second supplementary result data items.

6. The server of claim 5, wherein the processor is configured to:
generate a first quality loss function, a first cost loss function, a first efficiency loss function, and a first total loss function for the text data by inputting the text data into the predictive model based on the following [Equation 1];
generate a second quality loss function, a second cost loss function, a second efficiency loss function, and a second total loss function for the image data by inputting the image data into the predictive model based on the following [Equation 1]; and
generate a third quality loss function, a third cost loss function, a third efficiency loss function, and a third total loss function for the supplementary data by inputting the supplementary data into the predictive model based on the following [Equation 1],
$$\begin{matrix}[ Equation 1 ] & \\ \begin{matrix}L = w 1 \cdot {L}_{quality} + w 2 \cdot {L}_{cost} + w 3 \cdot {L}_{effciency} & ( w 1 + w 2 + w 3 = 1 )\end{matrix} & ( 1 )\end{matrix}$$
$$\begin{matrix}{L}_{quality} = {β}_{1} \cdot {L}_{accuracy} + {β}_{2} \cdot {L}_{completeness} & ( {β}_{1} + {β}_{2} = 1 )\end{matrix} \qquad ( 2 )$$
$${\begin{matrix}{L}_{cost} = {δ}_{1} \cdot {L}_{token} + {δ}_{2} \cdot {L}_{overhead} & ( {δ}_{1} + δ\end{matrix}}_{2} = 1 ) \qquad ( 3 )$$
$$\begin{matrix}{L}_{effciency} = {y}_{1} \cdot {L}_{time} + {y}_{2} \cdot {L}_{computation} & ( {y}_{1} + {y}_{2} = 1 )\end{matrix} \qquad ( 4 )$$
where L denotes the first total loss function, the second total loss function, and the third total loss function, L_{quality} denotes the first quality loss function, the second quality loss function, and the third quality loss function, L_{cost} denotes the first cost loss function, the second cost loss function, and the third cost loss function, L_{efficiency} denotes the first efficiency loss function, the second efficiency loss function, and the third efficiency loss function, w1, w2, w3 denote respective weights for the quality loss function, the cost loss function, and the efficiency loss function, L_{accuracy} denotes a value obtained by dividing a correct score for a domain, L_{completeness} denotes a completeness score value for a domain, β₁, β₂ denote weight values for calculating the quality loss function, Lₜₒₖₑₙ denotes a calculated value for tokens relative to price, L_{overhead} denotes a cost total value excluding price, δ₁, δ₂ denote weight values for calculating the cost loss function, Lₜᵢₘₑ denotes a ratio value for actual processing time, L_{computation} denotes a ratio value for the number of tokens used, and y₁, y₂ denote weight values for calculating the efficiency loss function.

7. The server of claim 6, wherein the predictive model is trained additionally on the basis a plurality of supplementary data items, a plurality of first text result data items, a plurality of second text result data items, a plurality of first image result data items, a plurality of second image result data items, a plurality of first supplementary result data items, and a plurality of second supplementary result data items, in addition to a plurality of total loss functions, a plurality of quality loss functions, a plurality of cost loss functions, and a plurality of efficiency loss functions.

8. The server of claim 6, wherein the processor is configured to:
determine that the customized model is a user-customized model when the customized model is equal to or less than a preset first model threshold; and
determine that the customized model has partial errors when the customized model is equal to or greater than the first threshold, but equal to or less than a second threshold set greater than the first threshold.

9. The server of claim 8, wherein the processor is configured to: determine that the customized model has very serious errors when the customized model is greater than or equal to the first threshold and the second threshold and retrain the customized model in the predictive model only when the customized model is greater than or equal to the first threshold and the second threshold; and
transmit the customized model to the external electronic device of the user only when the customized model does not exceed the second threshold.

10. A method of operating a server for recommending a customized model based on a predictive model, the method is configured to:
receive at least one user data item from an external electronic device of the user through the communication interface;
determine text data for the user by inputting the at least one user data item into a first sub-deep learning model through a processor;
determine image data for the user by inputting the at least one user data item into a second sub-deep learning model through the processor;
determine a customized model for the user by inputting at least one or more of the text data and/or the image data into the predictive model through the processor; and
transmit the customized model to the external electronic device of the user through the communication interface,
wherein the predictive model is trained on the basis of a plurality of text data items and a plurality of image data items, a plurality of customized models, first result data in which the plurality of customized models is determined to be accurate, second result data in which some of the plurality of customized models is determined to have errors, and third result data in which the plurality of customized models is determined to have errors.

11. The method of claim 10, wherein the at least one user data item includes sentence data created by the user, translation data created by the user, summary data created by the user, conversational data created by the user, voice data sensed or produced by the user, tactile data sensed or produced by the user, olfactory data sensed or produced by the user, input image data visually confirmed by the user or input by the user, analysis data of the user, and mathematical operation data of the user.

12. The method of claim 11, wherein the method is configured to:
determine the text data by inputting at least one of the sentence data, the translation data, the summary data, and the conversational data into the first sub-deep learning model;
classify the text data as first text result data when it is determined that the text data does not exceed a preset text threshold; and
classify the text data as second text result data when it is determined that the text data exceeds the text threshold,
wherein the first sub-deep learning model is trained on the basis of a plurality of user data items, a plurality of sentence data items, a plurality of translation data items, a plurality of summary data items, and a plurality of conversational data items, and a plurality of text data items, a plurality of first text result data items, and a plurality of second text result data items.

13. The method of claim 12, wherein the method is configured to:
determine the image data by inputting at least one of the input image data, the analysis data, and the at least one user data item into the second sub-deep learning model;
classify the image data as first image result data when it is determined that the image data does not exceed a preset image threshold; and
classify the image data as second image result data when it is determined that the image data exceeds the image threshold,
wherein the second sub-deep learning model is trained on the basis of a plurality of user data items, a plurality of analysis data items, and a plurality of input image data items, and a plurality of image data items, a plurality of first image result data items, and a plurality of second image result data items.

14. The method of claim 13, wherein the method is configured to:
determine supplementary data for the user by inputting at least one of the at least one user data item, the voice data, the tactile data, and the olfactory data into a third sub-deep learning model;
classify the supplementary data as first supplementary result data when it is determined that the supplementary data does not exceed a preset supplementary threshold; and
classify the supplementary data as second supplementary result data when it is determined that the supplementary data exceeds the supplementary threshold,
wherein the third sub-deep learning model is trained on the basis of a plurality of user data items, a plurality of voice data items, a plurality of tactile data items, and a plurality of olfactory data items, a plurality of supplementary data items, a plurality of first supplementary result data items, and a plurality of second supplementary result data items.

15. The method of claim 14, wherein the method is configured to:
generate a first quality loss function, a first cost loss function, a first efficiency loss function, and a first total loss function for the text data by inputting the text data into the predictive model based on the following [Equation 1];
generate a second quality loss function, a second cost loss function, a second efficiency loss function, and a second total loss function for the image data by inputting the image data into the predictive model based on the following [Equation 1]; and
generate a third quality loss function, a third cost loss function, a third efficiency loss function, and a third total loss function for the supplementary data by inputting the supplementary data into the predictive model based on the following [Equation 1],
$$\begin{matrix}[ Equation 1 ] & \\ \begin{matrix}L = w 1 \cdot {L}_{quality} + w 2 \cdot {L}_{cost} + w 3 \cdot {L}_{effciency} & ( w 1 + w 2 + w 3 = 1 )\end{matrix} & ( 1 )\end{matrix}$$
$$\begin{matrix}{L}_{quality} = {β}_{1} \cdot {L}_{accuracy} + {β}_{2} \cdot {L}_{completeness} & ( {β}_{1} + {β}_{2} = 1 )\end{matrix} \qquad ( 2 )$$
$${\begin{matrix}{L}_{cost} = {δ}_{1} \cdot {L}_{token} + {δ}_{2} \cdot {L}_{overhead} & ( {δ}_{1} + δ\end{matrix}}_{2} = 1 ) \qquad ( 3 )$$
$$\begin{matrix}{L}_{effciency} = {y}_{1} \cdot {L}_{time} + {y}_{2} \cdot {L}_{computation} & ( {y}_{1} + {y}_{2} = 1 )\end{matrix} \qquad ( 4 )$$
where L denotes the first total loss function, the second total loss function, and the third total loss function, L_{quality} denotes the first quality loss function, the second quality loss function, and the third quality loss function, L_{cost} denotes the first cost loss function, the second cost loss function, and the third cost loss function, L_{efficiency} denotes the first efficiency loss function, the second efficiency loss function, and the third efficiency loss function, w1, w2, w3 denote respective weights for the quality loss function, the cost loss function, and the efficiency loss function, L_{accuracy} denotes a value obtained by dividing a correct score for a domain, L_{completeness} denotes a completeness score value for a domain, β₁, β₂ denote weight values for calculating the quality loss function, Lₜₒₖₑₙ denotes a calculated value for tokens relative to price, L_{overhead} denotes a cost total value excluding price, δ₁, δ₂ denote weight values for calculating the cost loss function, Lₜᵢₘₑ denotes a ratio value for actual processing time, L_{computation} denotes a ratio value for the number of tokens used, and y₁, y₂ denote weight values for calculating the efficiency loss function.

16. The method of claim 15, wherein the predictive model is trained additionally on the basis a plurality of supplementary data items, a plurality of first text result data items, a plurality of second text result data items, a plurality of first image result data items, a plurality of second image result data items, a plurality of first supplementary result data items, and a plurality of second supplementary result data items, in addition to a plurality of total loss functions, a plurality of quality loss functions, a plurality of cost loss functions, and a plurality of efficiency loss functions.

17. The method of claim 15, wherein the method is configured to:
determine that the customized model is a user-customized model when the customized model is equal to or less than a preset first model threshold; and
determine that the customized model has partial errors when the customized model is equal to or greater than the first threshold, but equal to or less than a second threshold set greater than the first threshold.

18. The method of claim 17, wherein the method is configured to:
determine that the customized model has very serious errors when the customized model is greater than or equal to the first threshold and the second threshold and retrain the customized model in the predictive model only when the customized model is greater than or equal to the first threshold and the second threshold; and
transmit the customized model to the external electronic device of the user only when the customized model does not exceed the second threshold.
